(19) United States
(12) Patent Application Publication
(10) Pub. No.: US 2006/0167786 A1
(43) Pub. Date: Jul. 27, 2006

(54) System and method for intra-day pricing of mutual funds

(76) Inventors: Satnam S. Gambir, Aliso Viejo, CA (US); Timothy Y. Kan, West Covina, CA (US)

Correspondence Address: Daniel H. Golub, 1701 Market Street, Philadelphia, PA, 19103, US

(21) Appl. No.: 11/270,316

(22) Filed: Nov. 9, 2005

Related U.S. Application Data
(60) Provisional application No. 60/626,391, filed on Nov. 9, 2004.

(51) Int. Cl. G06Q 40/00

(52) U.S. Cl. 705/37

(57) ABSTRACT

A computer-implemented method for facilitating the purchase and sale of shares in an open-ended mutual fund, in a single or plurality of different currencies, during a trading day when assets held by the mutual fund fluctuate in value as the assets trade on one or more exchanges. The trading day is divided into a plurality of pricing cycles. A net asset value, for a single or plurality of different currencies is received wherein the net asset value is associated with each share in the fund based on the values at which individual assets held in the fund traded on one or more exchanges immediately prior to the end of the pricing cycle and the number of shares purchased from the fund and redeemed by the fund during the prior pricing cycle. The number of shares associated with the trade is posted during a subsequent trading cycle and one or more reports are displayed immediately after posting the share value. Outstanding shares and available balances for shareholder accounts are produced at the end of the pricing cycle.

### Reference to Related Applications

This application claims the benefit of U.S. Provisional Application No. 60/626,391 filed on Nov. 9, 2004, entitled “System and Method for Intra-Day Pricing of Mutual Funds.”

### BACKGROUND

An open-ended mutual fund may hold many types of assets, including assets such as securities that trade on various exchanges. The net asset value (NAV) of the fund generally corresponds to the market price of the assets held by the mutual fund divided by the number of outstanding shares in the fund. The NAV is calculated at the end of a trading day. The numbers of shares purchased or redeemed in the trade during are available to the trader on a subsequent day.

### FIELD OF THE INVENTION

This invention relates to a system and method for facilitating the trading of shares in an open ended mutual fund wherein the net asset value of the share is calculated and posted, in real time, for a plurality of pricing cycles during a trading day.

### SUMMARY OF THE INVENTION

The present invention is directed to a computer-implemented method for facilitating the purchase and sale of shares in an open-ended mutual fund during a trading day when assets held by the mutual fund fluctuate in value as the assets trade on one or more exchanges. The method comprises the steps of dividing at least a portion of the trading day into a plurality of pricing cycles such that the interval between the beginning of successive pricing cycles is 4 hours or less. A pricing cycle is defined with components comprising a name, an identification number, a fund transaction source, a stop trading value, an override value, a fund cutoff time, and an estimate cutoff time. At the end of each pricing cycle, a net asset value is received wherein the net asset value is associated with each share in the fund based on the values at which individual assets held in the fund traded on one or more exchanges immediately prior to the end of the pricing cycle and the number of shares purchased from the fund and redeemed by the fund during the prior pricing cycle. One or more trades for the purchase or sale of shares during the pricing cycle are entered. The number of shares associated with the trade is posted during one of the subsequent pricing cycles of the trading day, wherein the shares purchased or redeemed during the pricing cycle are purchased or sold at a price equivalent to the net asset value determined at the end of said pricing cycle. Outstanding shares for the mutual fund and available balances for the shareholder accounts in a mutual fund are produced at the end of the pricing cycle. One or more reports are displayed for the one or more trades immediately after posting the value of the trade.

In accordance with a further aspect, the present invention is directed to a computer-implemented method for facilitating the purchase and sale of shares in an open-ended mutual fund in a plurality of different currencies during a trading day when assets held by the mutual fund fluctuate in value as the assets trade on one or more exchanges. The method is comprised of the steps of dividing at least a portion of the trading day into a plurality of pricing cycles such that the interval between the beginning of successive pricing cycles is 4 hours or less. The pricing cycle is defined by components comprising a name, an identification number, a fund transaction source, a stop trading value, an override value, a fund cutoff time, an exchange rate and an estimate cutoff time. For each of the plurality of currencies, a net asset value associated with each share in the fund is received based on the values at which individual assets held in the fund traded on one or more exchanges prior to the end of the pricing cycle and the number of shares purchased from the fund and redeemed by the fund during the prior pricing cycle. Each of the plurality of different currencies are used to complete requests to purchase at least some shares from the fund and to redeem at least some shares by the fund made during said pricing cycle at a price equivalent to the net asset value determined at the end of said pricing cycle. One or more trades for the purchase or sale of shares during the pricing cycle are entered. The number of shares associated with the trade is posted during one of the subsequent pricing cycles of the trading day, wherein the shares purchased or redeemed during the pricing cycle are purchased or sold at a price equivalent to the net asset value determined at the end of said pricing cycle. Outstanding shares for the mutual fund and available balances for the shareholder accounts in a mutual fund are produced at the end of the pricing cycle. One or more reports are displayed for the one or more trades immediately after posting the value of the trade.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain features of the invention.

In the drawings:

FIG. 1 is a diagram illustrating the operation of the present invention to implement intra-day pricing of a mutual fund at one hour intervals during a trading day;

FIG. 2 illustrates an exemplary price cycle name definition screen that may be used in connection with the present invention;

FIG. 3 illustrates an exemplary trading cutoff time entry screen that may be used in connection with the present invention;

FIGS. 4A and 4B illustrate an exemplary price cycle group creation screen that may be used in connection with the present invention;

FIG. 5 illustrates an exemplary special business day entry screen that may be used in connection with the present invention;

FIG. 6 illustrates an exemplary settlement cycle entry screen that may be used in connection with the present invention;

FIG. 7 illustrates an exemplary screen that may be used in connection with the present invention;

FIG. 8 illustrates an exemplary screen that may be used in connection with the present invention;

FIG. 9 illustrates an exemplary screen that may be used in connection with the present invention;

FIG. 10 illustrates an exemplary screen that may be used in connection with the present invention;

FIGS. 11A and 11B illustrate an exemplary account holding screen that may be used in connection with the present invention;

FIG. 12 illustrates an exemplary parameter entry screen that may be used in connection with the present invention;

FIG. 13 illustrates an exemplary parameter entry screen that may be used in connection with the present invention;

FIG. 14 illustrates an exemplary process dividend reporting screen that may be used in connection with the present invention;

FIG. 15 illustrates an exemplary process rollover screen that may be used in connection with the present invention;

FIG. 16 illustrates an exemplary screen hat may be used in connection with the present invention;

FIG. 17 illustrates an exemplary screen that may be used in connection with the present invention;

FIG. 18 illustrates an exemplary screen that may be used in connection with the present invention; and

FIG. 19 is a diagram illustrating the operation of the present invention to implement intra-day pricing of a mutual fund in multiple currencies.

### DETAILED DESCRIPTION OF THE PREFERRED EMBODIMENT

In the present invention, the NAV of an open-ended mutual fund is calculated at several times during a trading day. The NAV is posted during one of the subsequent pricing cycles of the trading day, wherein the shares purchased or redeemed during the pricing cycle are purchased or sold at a price equivalent to the net asset value determined at the end of the prior pricing cycle. Immediately after posting the NAV, outstanding shares for the mutual fund and available balances for the shareholder accounts are produced and displayed in one or more reports.

For purposes of the present invention, a trading day corresponds, for example, to the time period during a business day that assets held by the fund trade on an exchange (such as the NYSE). During a trading day, the value of assets held by the mutual fund will vary as the trading price of such assets fluctuates on the exchange.

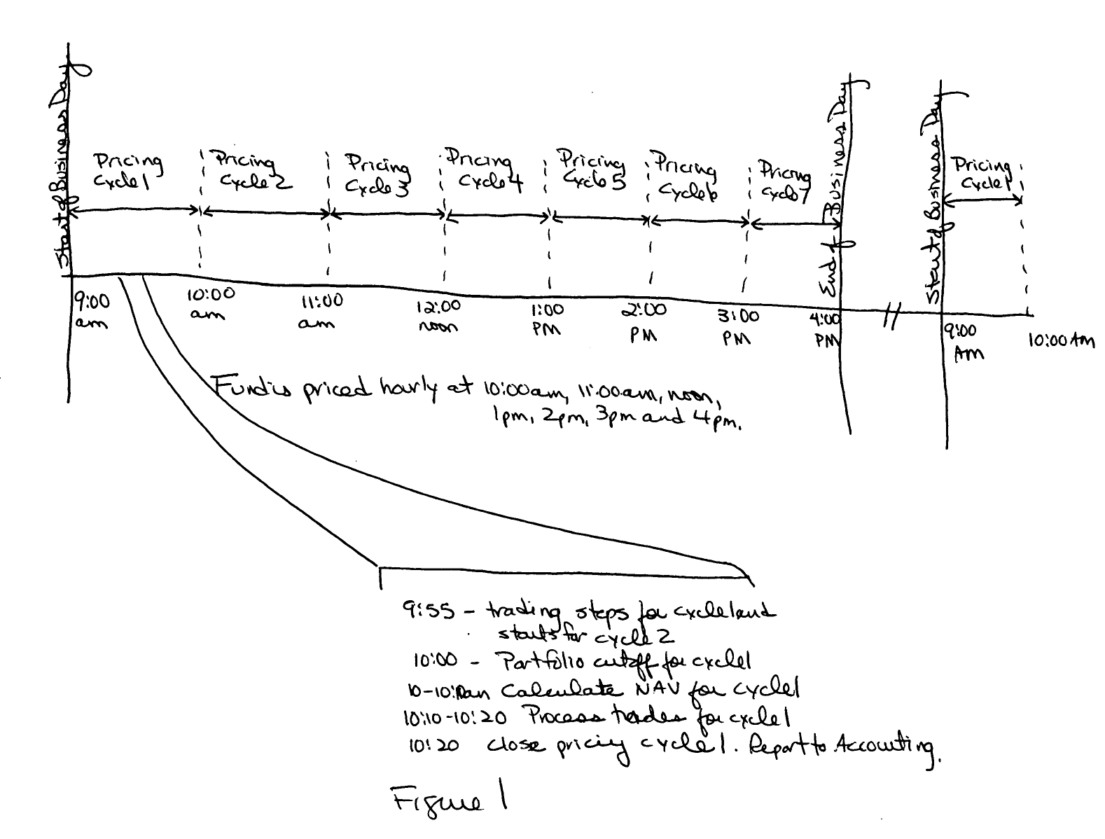

Referring now to FIG. 1, there is shown a diagram illustrating one embodiment of the operation of the present invention to implement intra-day pricing of a mutual fund having price cycles of one hour intervals during a trading day that extends from 9:00 am to 4:00 pm. During the first pricing cycle (i.e., 9:00 am-10:00 am), the assets held by the mutual fund are traded on various exchanges. From 3:55 pm (on the previous trading day) to 9:55 am (on the current trading day), the mutual fund receives orders from the public or institutional investors to purchase shares in the mutual fund and, during the same time interval, the mutual fund receives requests from the public or institutional investors to redeem shares of the mutual fund. At 9:55 am (wherein the trading cutoff time is 5 minutes before the end of first pricing cycle), the mutual fund ceases accepting such purchase orders or redemption requests for the first pricing cycle. As described below, all purchase orders or redemption requests received from 3:55 pm (on the previous trading day)-9:55 am (on the current trading day) are processed using the NAV calculated at the end of the first pricing cycle, and all purchase orders or redemption requests received after this 9:55 am cutoff (and before the next cutoff at 10:55 am) are processed using the NAV calculated at the end of the second pricing cycle.

At 10:00 am (the fund cutoff time), trading for the first pricing cycle of the assets held by the mutual fund on various exchanges ends, and trading for the next pricing cycle of the assets held by the mutual fund on various exchanges begins.

Between 10:00 am-10:10 am, a NAV for each share in the mutual fund is determined using the market price of each asset held by the fund at the time trading of assets held by the mutual fund when the first pricing cycle ended (i.e., 10:00 am).

Next, between 10:10 am-10:20 am, all purchase orders or redemption requests received from 9:00 am-9:55 am are processed using the NAV calculated at the end of the first pricing cycle (i.e., the NAV calculated between 10:00 am-10:10 am).

At 10:20 am, a report is sent to the accounting department of the mutual fund identifying the purchase orders and redemption requests processed for the first pricing cycle.

Referring still to FIG. 1, the above described process is then repeated during each subsequent one-hour interval, in order to implement intra-day pricing of the mutual fund on an hourly basis throughout the trading day.

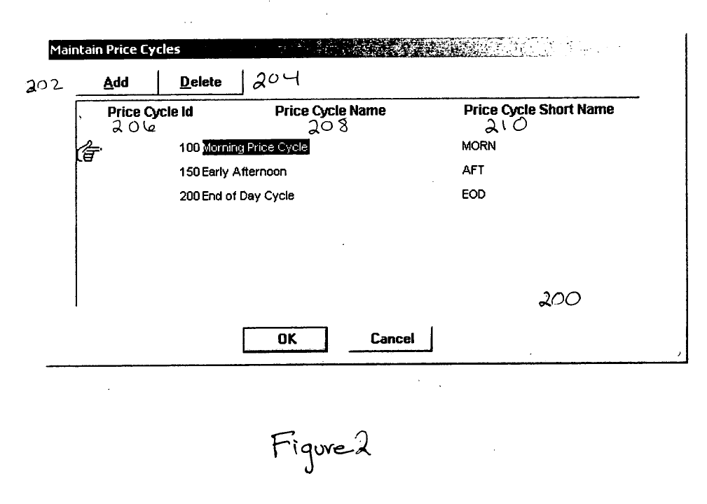

The implementation of this system and method is illustrated in FIGS. 2-19 which depict graphical user interface screen for implementing one embodiment of the present invention. The components of a pricing cycle are defined by a price cycle name and Id, trading cutoff time values, fund cutoff value, estimate cutoff value and optionally foreign exchange (“FX”) rate source. The FX rate source is a required component for a pricing cycle for a multicurrency embodiment. The system and method of the present invention identifies the components of a pricing cycle by the entries within a price cycle group and the price cycle name.

Referring to FIG. 2, a price cycle name and Id are created by accessing the Price Cycle screen 200 from an Administrator screen. The Price Cycle screen lists the Price Cycle Id number field 206, the Price Cycle Name field 208 and the Price Cycle Short Name field 210. The price cycle name may be associated with a plurality of values for trading cutoff time values, fund cutoff value, estimate cutoff value and optionally FX rate source and one or more price cycle groups. The price cycle name, price cycle Id number and price cycle short name are stored on the system in a price cycle table. The Price Cycle Id number 206 is an identifier for the price cycle name. It is a user defined field and used to determine the order of the price cycle names throughout day when used in a Price Cycle Group. As illustrated in FIG. 2, a Price Cycle Id number is selected that leaves a gap between price cycle names to allow the addition of more price cycle names. The Price Cycle Id number 206 has a numeric value of 1 or greater, 255 or less. The minimum value is 1 and the maximum value is 255. The Price Cycle Short Name 210 is the short name for the price cycle and is used on drop down lists and in reports and screens where space is a consideration. Error messages are displayed, if the user does not enter any data or if the user enters a name already entered in the system. The Add Price Cycle Button 202 adds a new price cycle name to the Price Cycles table. The Delete Price Cycle Button 204 deletes a price cycle name from the Price Cycles table. Clicking this button 204 validates that the price cycle name is not currently used by the system. If not in use, the system deletes the price cycle name. If the price cycle name selected for deletion is currently used, the system generates an error message indicating the price cycle name is currently in use and may not be deleted. The OK Button validates the entered information and save all changes made to price cycle names. When the user selects the Cancel Button, the system exits the Maintain Price Cycles screen without saving the data input.

Additional components for a pricing cycle are further defined by its trading cutoff time definition which controls the deadlines associated with entering trades. These components are entered via a Trading Cutoff Screen 300 as illustrated in FIG. 3. The deadlines are entered in terms of minutes before the fund cutoff time, as described below, and can vary by fund transaction source. The Trading Cutoff Time screen 300 contains a Trading Cutoff Definition 302, a New Definition button 304, a Delete Definition button 306, a Save Definition button 308, a Trading Definition Id 310, Name field 312, the Fund Transaction Source field 314, Stop Trading field 316, Override field 318 and Use Last Cycle field 320. The Trading Cutoff Definition field 302 is a drop down list of existing trading cutoff names from which only a single value is selected. When an existing trading cutoff definition is entered into this field 302, the system auto fills the Trading Definition Id 310, the Name 312, the Fund Transaction Source 314, the Stop Trading field 316, the Override field 318 and Use Last Cycle field 320. The Fund Transaction Source field 314 is a drop down list of the fund transaction sources. For example, the sources may comprise telephone, mail, facsimile, internet entries, etc. The system has a default row of All. Any additional rows override the All source for the defined source. Sources not defined default to the All definition. The Stop Trading field 316 is the number of minutes before fund cutoff time. In one embodiment, the default for the field is 0, which indicates that the stop trading deadline is the same as the fund cutoff time. For the embodiment illustrated in FIG. 1, the stop trading minutes has a value of 5 minutes and the fund cutoff time is 10:00 am. The Override field 318 is the number of minutes before fund cutoff wherein users can override the system entering trades for the current cycle between the stop trading deadline and override deadline, but cannot enter trades past the override deadline. The exception to this is an authorized user who can enter trades up until the next posting cycle begins. In one embodiment, the Stop Trading value is zero indicating that no warning period is defined and the Override values is zero indicating that no override period is allowed. The Use Last Cycle field 320 indicates whether the system sets all transactions done for the selected fund transaction source to use the NAV based on the last price cycle. FIG. 3 illustrates an example wherein the Value Added Trading Cutoff Time parameter is defined for All Transaction Sources having a Stop Trading value of 10 minutes, an Override value of 5 minutes and does not use the last cycle to determine stop trading and override values.

The Trading Cutoff Time screen 300 also allows the user to create a new trading cutoff time definition or delete a trading cutoff time definition. Selecting the New Definition button 314, the current window of data is cleared and the next trading definition Id is automatically assigned and a new name is entered in the Trading Cutoff Times Name field 312. The Delete definition button 306 deletes information for an existing trading cutoff times definition. Selecting this button 306 validates whether or not the trading cutoff times definition is currently used by a price cycle group. Selecting the Save button 308, saves all data added, deleted or changed on the screen and the rows added or deleted on the screen for the trading cutoff times definition.

The system also provides for adding or deleting trading cutoff times for the trading cutoff times definition currently selected. Selecting the Add trading cutoff times button 322, allows the user to add new cutoff times for a designated Fund Transaction Source 314. For example, a user could add a trading cutoff time for a fund transaction source Mail to the Value Added Trading Cutoff Time parameter by clicking the Add button 322, selecting Mail from the Fund Transaction source dropdown filed 314, enter a value of 5 minutes to the Stop Trading field 316 and enter No for the Use Last Cycle field 320. The Delete trading cutoff times button 324, deletes a row for a Fund Transaction Source for the Trading Cutoff Times parameter currently selected. For example, a user could delete a trading cutoff time from the Fund Transaction Source field of Internet 314 by placing the cursor on the Fund Transaction Source 314 row of Internet and clicking the Delete button 324.

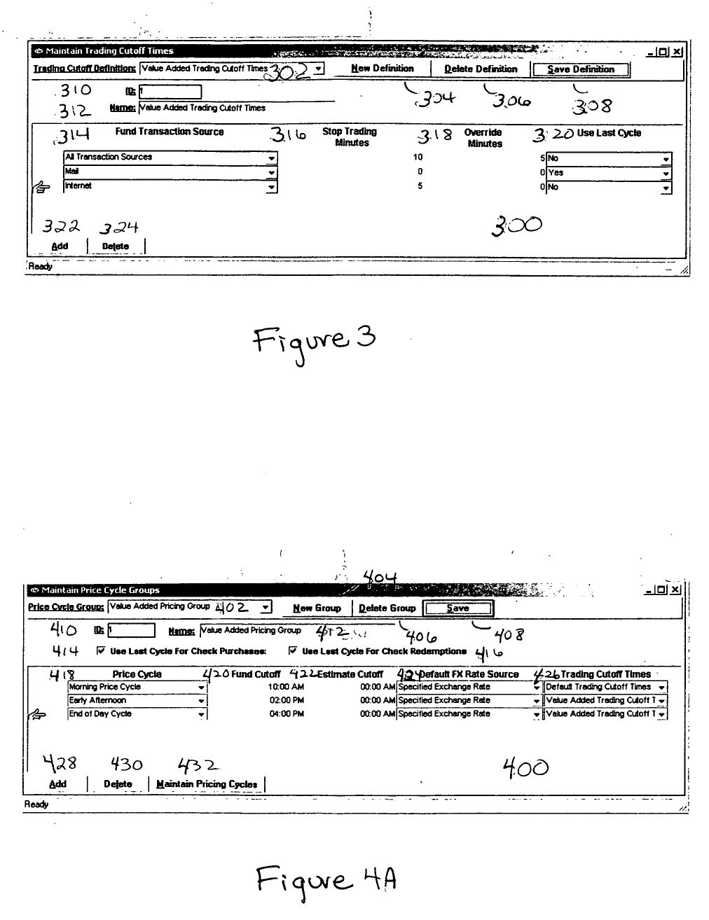

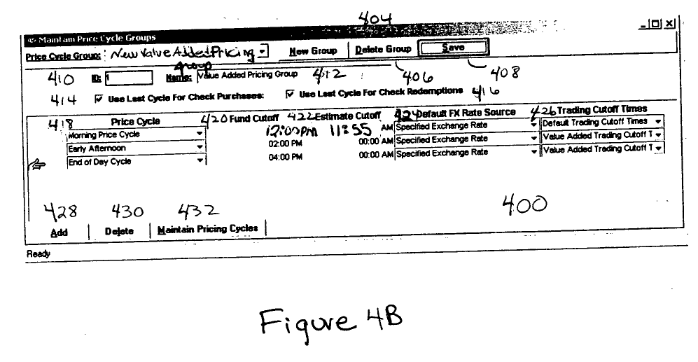

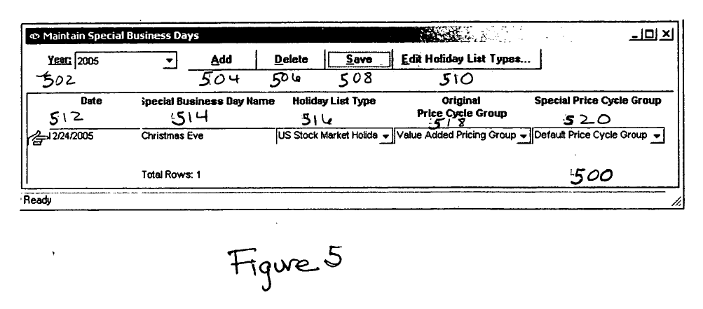

A pricing cycle's fund cutoff, estimate cutoff and optionally FX rate source values are defined using the Price Cycle Group screen, FIG. 4. The Price Cycle Groups screen 400 contains a Price Cycle Group field 402, a New Group button 404, a Delete Group button 406, a Save button 408, a Price Cycle group Id 410, a Price Cycle Group name 412, a “use last cycle for check purchase” checkbox 414, a “use last cycle for check redemption” checkbox 416, a Price Cycle drop down menu 418, a Fund Cutoff field 420, an Estimate Cutoff field 422, a Default FX Rate Source dropdown field 424 and Trading Cutoff Times dropdown field 426. A Price Cycle Group may comprise a single pricing cycle or a plurality of pricing cycles. The Price Cycle Group field 402 is a drop down list of existing price cycle groups. The Price Cycle Group name 412 and the Price Cycle Group Id 410 are the name and the Id of the selected price cycle group, respectively. When the “use last cycle for check purchases” checkbox 414 is checked the system will set all check purchase transactions to use the NAV for the last cycle. The price cycle dropdown field 418 comprises a list of the existing price cycle names. The Fund Cutoff Time 420 indicates the time to stop trading. When the Price Cycle Group field 402 is selected for an existing price cycle group, the system auto fills fields for the Price Cycle Group Id 410, the Price Cycle Group name 412, the “last cycle used on check purchases” checkbox 414, the ‘last cycle used on check redemptions’ checkbox 416, the Price Cycle name 418, the Fund Cutoff Time 420, Estimate Cutoff field 422, the Default FX Rate Source 424, and the Trading Cutoff Times definition 426. The Fund Cutoff field 420 is the cutoff time for the pricing cycle. This is used to define the stop trading time 316 and the override minutes 318 of FIG. 3. The field 420 is a time field with an HH:MM AM/PM mask and must contain a valid time. In one embodiment, acceptable time ranges are 12:00 AM to 11:59 PM. The default FX rate source menu 424 is a drop down list of the source names from the Exchange Rate Sources. This field 424 is required when adding a new row for a price cycle group for a fund group on which multi-currency is enabled. These values for the exchange rate sources are maintained by the system. For example, a fund might use the Bloomberg exchange rates for the morning cycle and Knight-Ridder for the afternoon prices. For fund groups where multi-currency is not enabled, the system defaults to the FX Rate Source for the fund group. The Trading Cutoff Times field 426 is a group of fund transaction sources and their associated cutoff times as described above for FIG. 3. New pricing cycles are added to the drop down list using the Maintain Price Cycles button 432.

FIG. 4A illustrates an embodiment wherein a price cycle group is comprised of three pricing cycles-early morning price cycle, early afternoon, end of day cycle. The components of the pricing cycle are defined by its row entries for the Fund Cutoff field 420, the Estimate Cutoff field 422, the Trading Cutoff Times definition and optionally the Default FX Rate Source. For example, one pricing cycle is associated with the name early morning price cycle, having a fund cutoff time of 10:00 AM, no estimated cutoff time, a specified rate exchange and default trading cutoff times definition. The second pricing cycle is associated with the price cycle name early afternoon, a fund cutoff time of 2:00 PM, no estimated cutoff time, a specified rate exchange and value added trading cutoff times definition.

The system can use a price cycle name only one time within a given price cycle group. The system, however, may use a price cycle name in one or more price cycle groups to define different pricing cycles. When a price cycle name is used in a different price cycle group it may be associated with different values for fund cutoff, estimate cutoff and optionally FX rate source. For example as illustrated in FIG. 4A, the pricing cycle morning is defined within price cycle group Value Added Pricing Group having the name morning price cycle, a fund cutoff of 10:00 AM and default trading cutoff times. As further illustrated in FIG. 4B, the pricing cycle first morning is defined within the price cycle group New Value Added Pricing Group having the price cycle name morning price cycle, a fund cutoff of 12:00 PM, an estimate cutoff of 11:55 AM and default trading cutoff times. Even though the same price cycle name is used, morning price cycle, the system of the present invention recognizes the two different pricing cycles by linking the components of a pricing cycle through the entries within a price cycle group to the price cycle name.

The user may also add or delete a pricing cycle, from the price cycle group, by selecting the Add price cycle button 428 or the Delete price cycle button 430. When the user selects the Add price cycle button, a new pricing cycle row is added in the price cycle field 418, to the Price Cycle Group currently selected. Selecting the Delete price cycle button, deletes a pricing cycle row from the Price Cycle Group currently selected. The user then selects the Maintain Price Cycles button 432 to add, delete or edit a pricing cycle which appears in the drop down list 418.

The user may also create or delete a new price cycle group. To create a new price cycle group, the user selects the new group button 412 which prompts the user to save data if data was changed for the current pricing cycle group and not saved or clear the current window of data. The system automatically assigns the next price cycle group Id. If a user tries to add a price cycle group and the Id of the new group exceeds the maximum price cycle groups permitted on the system (255) then the user receives an error message. The Price Cycle Group Name field 412 is made available for data entry. When the user selects the delete group button 406, the system deletes information for an existing price cycle group. Selecting this button 406 validates whether or not the price cycle group is currently used by the system. For example, the price cycle group was previously assigned to a fund or the price cycle group was specified in special business days as described below. If the price cycle group is currently in use, then the user receives an error message and the group is not deleted. If the price cycle group is not currently in use, then the user clicks the yes button to delete the group. The user may also elect to save the current price cycle group by selecting the save button. Clicking the save button triggers a save on all information on the window including modified fields, and added or deleted rows.

The method of the present invention also provides for the creation of price cycle groups for special business days when the fund may price at a non-standard time, or may close early. Examples of a Special Business Day are when the fund cutoff time changes or a different set of pricing cycle are used such as a day wherein the market closes early or the government declares a national emergency. Users may define a Price Cycle Group that specifies the new closing time, or changed pricing cycles and specify in Maintain Special Business Days that these special Price Cycle Groups should be used for any Funds that currently use the original Price Cycle Group.

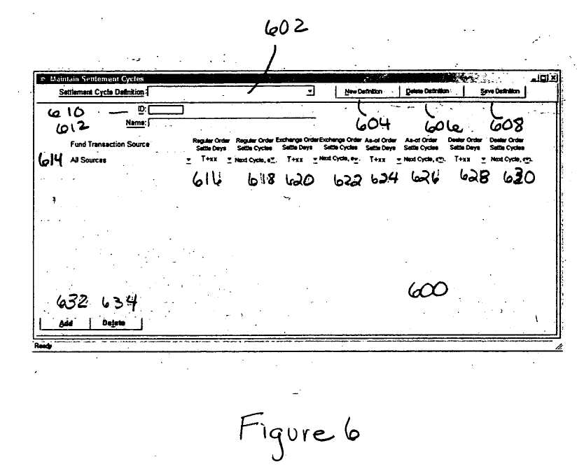

With reference to FIG. 5, a Maintain Special Business Days screen 500 is accessed from an Administrator screen. The Maintain Special Business Days screen 500 includes a year field 502, add button 504, delete button 506, save button 508, edit holiday list types field 510, a date field 512, a Special Business Day Name field 514, a Holiday List Type field 516, an Original Price Cycle Group field 518, and a Special Price Cycle Group field 520. The Year field 502 is a drop down list of existing years from which only a single value may be selected. When this field is selected the following fields in the grid will auto-fill: Special Business Day Name, Holiday List Type (drop down list), Original Price Cycle Group (drop down list), Special Business Days Price Cycle Group (drop down list). The Special Business Days Name 514 field is the name for the Special Business day entered by the user. The Holiday List Type Drop down list field 516 is a drop down list of Holiday List Types. The list types include US Stock Market Holidays and US Bank Holidays. The Original Price Cycle Group Drop Down field 518 indicates the Price Cycle Group originally assigned to the date indicated in field 512. It is a drop down list of Price Cycle Groups maintained in the system. The Special Business Days Price Cycle Group drop down list field 520 is also a list of Price Cycle Groups maintained in the system. These Price Cycle Groups contain alternate closing times and could contain fewer price cycles to accommodate an alternate closing arrangement for the fund on the specified special business day. The user selects the Add Button 504 to add a new record to special business day price cycle group. The Delete Button 506 is used to delete information for an existing special business day price cycle group. The Save Button 508 is used to save all information on the screen for the special business days. The Edit Holiday List Types button 510 is used to edit the list of holidays maintained by the system. Holiday list types are user-defined lists of days when trading will not occur for a fund. Different types of funds will observe different trading days. Bond funds, for example, may not trade on US Bank Holidays, while Equity Funds may not trade on US Stock Market Holidays. A European fund may have a holiday list based on European holidays.

Settlement cycles are used to determine when a trade is expected to settle. Settlement cycles may differ depending on the transaction type and money transaction type. Settlement cycles are defined relative to the trading day and pricing cycle of the trade. For example, a trade may settle on the same day, next pricing cycle. Users may define settlement cycles for all money transaction types, creating exceptions when necessary. This group of settlement cycles is associated with a fund and used to determine the expected settlement date when trades are created. The Maintain Price Settlement Cycles screen 600 is accessed from an administrator screen. The Maintain Price Settlement Cycles screen 600 includes the Settlement Cycle Definition field 602, a New Definition button 604, a Delete Definition button 606, a Save Definition button 608, a cycle Id 610, Name field 612, Money Transaction Type field 614, Regular Order Settle Days field, 616, Regular Order Settle Cycles field 618, Exchange Order Settle Days field 620, Exchange Order Settle Cycles field 622, As-of Order Settle Days field 624, As-of Order Settle Cycles field 626, Dealer Order Settle Days field 628, Dealer Order Settle Cycles field 630. The information entered into these fields forms the Settlement Cycles. The Settlement Cycles definition field 602 is a drop down list of existing Settlement Cycles from which only a single value is selected. When this field 602 is selected, for an existing Settlement Cycle, the system auto fills the remaining fields. The Settlement Cycle Definition Id 610 and Name 612 fields indicate the Id and name of the selected Settlement Cycle. The Money Transaction Type drop field 614 is a drop down list of the system defined Money Transaction Types. The Money Transaction types include receive wire, send check, send wire and etc. The settlement cycles are categorized as regular order, exchange order, as-of order, and dealer order transactions. An exchange order transaction comprises a trade where shares are redeemed from one fund and the monetary value of those shares used to purchase shares in another fund for the same account registration. A dealer order is a transaction from the NSCC. An as-of order transaction comprises a transaction entered on a day for a pricing cycle of a prior day or a prior cycle of the same day. A regular order comprises all other transactions. The system has a default row of All that cannot be deleted and the user may add additional rows. The Regular Order Settle Days field 616 is a drop down list of Settlement Days with values of T+0, T+1, T+2, T+3 . . . T+30, wherein T is the day of the transaction. The default for the field is T+0. The Regular Order Settle Cycles field 618 is a drop down list of Settlement Cycles with values of Same Cycle, Next Cycle, Last Cycle, First Cycle, and Not Applicable. The Exchange Order Settle Days field 620 is a drop down list of Settlement Days with values T+0, T+1, T+2, T+3 . . . T+30, wherein T is the day of the transaction. The default for the field is T+0. The Exchange Order Settle Cycles 622 is a drop down list of Settlement Cycles with values of Same Cycle, Next Cycle, Last Cycle, First Cycle, and Not Applicable. The default for the field is Not Applicable. The As-of Order Settle Days field 624 is a drop down list of Settlement Days with values T+0, T+1, T+2, T+3 . . . T+30, wherein T is the day of the transaction. The default for the field is T+0. The As-of Order Settle Cycles field 626 is a drop down list of Settlement Cycles with values of Same Cycle, Next Cycle, Last Cycle, First Cycle, and Not Applicable. The default for the field is Not Applicable. The Dealer Order Settle Days field 628 is a drop down list of Settlement Days with values T+0, T+1, T+2, T+3 . . . T+30, wherein T is the day of the transaction, with a default value of T+0. The Dealer Order Settle Cycles field 630 is a drop down list of Settlement Cycles with values of Same Cycle, Next Cycle, Last Cycle, First Cycle, and Not Applicable. The default for the field is Not Applicable.

The user may create a new settlement cycle definition or delete an existing settlement cycle definition. When the user selects the New Definition button 602 a new Settlement Cycle definition is created. The system automatically assigns the next Settlement Cycle Definition Id. The user then clicks the Save Definition button 608 to save all information on the screen for the Settlement Cycles definition. Selecting this button 608 saves all added, changed or deleted data and all added rows or deleted rows. Settlement Cycles may be defined across all money transaction types or for one or more specific money transaction types. To add a new money transaction type row to the selected Settlement Cycle Definition, the user clicks the Add button 632. The user may also delete a money transaction type row, for an existing Settlement Cycle definition, by clicking the Delete button 634. The user may delete the entire Settlement Cycle Definition by clicking the Delete Definition button 606. Clicking this button 606 also validates whether or not the Settlement Cycle definition is currently used by a fund. If the Settlement Cycle definition is currently used, the system generates an error message. If the Settlement Cycles definition is not currently being used, then the system generates a message directing the user to click “Yes” to delete the definition or “No” to return to the Maintain Settlement Cycles screen without deleting the definition.

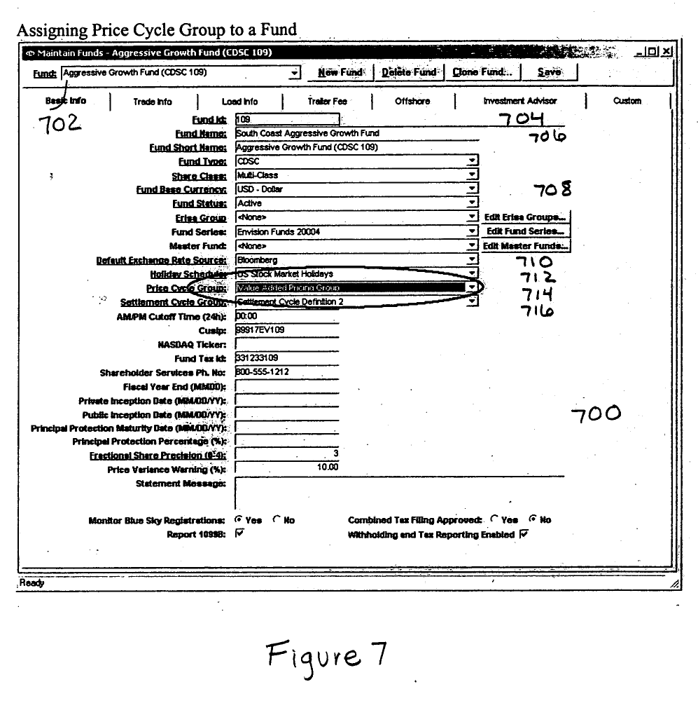

Referring to FIG. 7, the Maintain Funds screen 700 is shown illustrating the assignment of a price cycle group to a fund. The Maintain Funds screen 700 includes fields for the fund name 702, the fund Id 704, the fund name 706, the fund currency base 708, the default exchange rate source 710, the holiday schedule 712, the price cycle group 714 and the settlement group 716. A fund is selected from the fund drop down list. The user selects a Price Cycle group, defined as described above, from a drop down list of all the Price Cycle Groups defined in the system 714. In this example, the user has assigned the Value Added Pricing Group to the Aggressive Growth Fund. The New Fund Button is used to add a new fund to the system and presents a screen of empty fields for the user to fill. Delete Fund can be used to delete a fund that has not yet been used for trading. Clone Fund can be used to create a new fund from an existing fund.

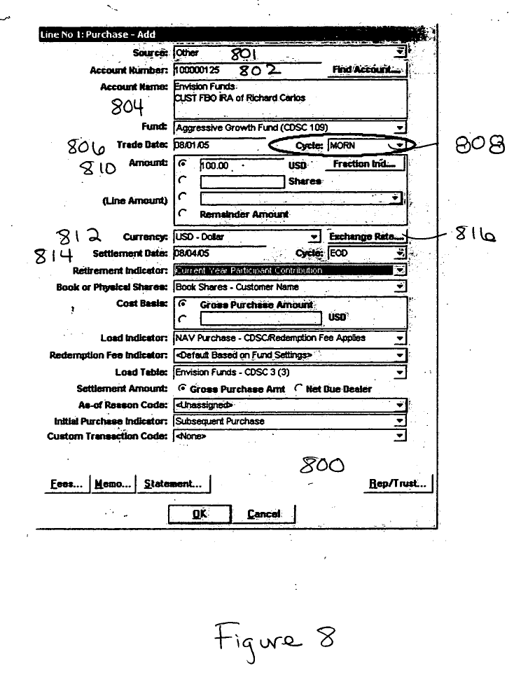

Referring to FIG. 8, the Purchase-Add screen 800 is shown illustrating entering a trade for the purchase or sale of shares during a pricing cycle. In addition to the purchase or sale of shares, pricing cycles are used in many other transaction screens such as redemption, exchange redemption, exchange purchase, dealer redemption, dealer purchase, transfer redemption, transfer purchase and others. As discussed for FIG. 7, the system associates a price cycle group with the fund for the trade entered in FIG. 8. The Purchase-Add screen 800 include fields for the source 801, the account number 802, the account name 804, the trade date 806, the Price Cycle name 808, the amount 810, the settlement date 814, the cycle for the settlement date 818, and the exchange rate 816. The source field 801 indicates where the source of the trade such as by phone, mail, facsimile, etc. Once a trade is received, the trade information, source 801, account number 802, the account name 804, the trade date 806 the Fund and the price cycle 808 are entered. Once a price cycle name is entered into field 808, the system links the price cycle name to the price cycle group assigned to the fund and retrieves the components that define the pricing cycle.

The price or net asset value for a fund is calculated at the end of the pricing cycle as illustrated in FIG. 1. The net asset value associated with each share in the fund is based on the values at which individual assets held in the fund traded on one or more exchanges immediately prior to the end of the pricing cycle and the number of shares purchased from the fund and redeemed by the fund during the prior pricing cycle. For a multi-currency trade, a net asset value, associated with each share in the fund, is calculated based on the values at which individual assets held in the fund traded on one or more exchanges prior to the end of the pricing cycle and the number of shares purchased from the fund and redeemed by the fund during the prior pricing cycle; wherein each of the plurality of different currencies are used to complete requests to purchase at least some shares from the fund and to redeem at least some shares by the fund made during said pricing cycle at a price equivalent to the net asset value determined at the end of said pricing cycle. The NAV is recorded in a single currency for a given fund and is converted to a different currency for reporting and display purposes. For multicurrency exchanges, the source of the exchange rate is specified in the price cycle group screen 400 under the Defaults FX Rate Source field 424, as illustrated in FIGS. 4A and 4B. Exchange rates are stored in exchange rates tables within the system. The price is received by the system and entered for each fund associated with the completed price cycle.

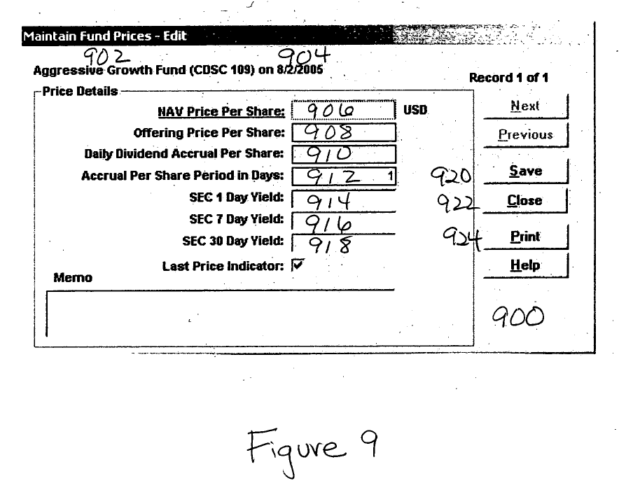

With reference to FIG. 9, the Maintain Fund Prices-Edit screen 900 illustrates entering the NAV after completion of the pricing cycle. The screen 900 contains a fund name 902 and date 904, NAV Price Per Share field 906, Offering Price Per Share field 908, Daily Dividend Accrual Per Share field 910, Accrual Per Share Period in Days save button 920 and print button 924. The NAV for a single share is entered into the NAV Price Per Share field 906. The remaining fields are enabled for certain fund types and accrual types. The last price indicator flags the last price of the day.

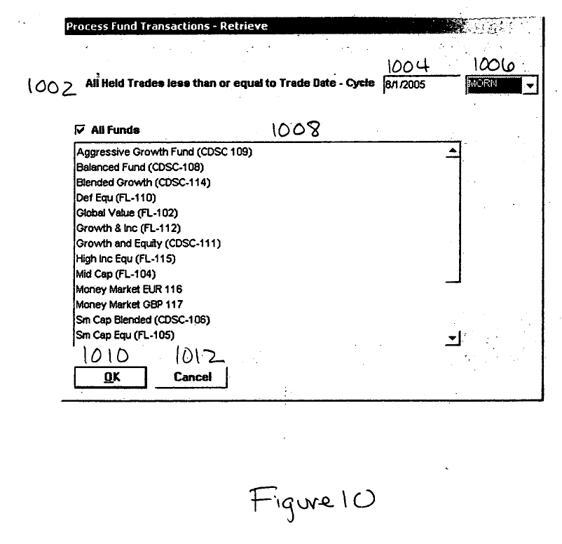

Once a trade is entered into the system, the trade is placed in a held state until a price becomes available at the end of the price cycle. Referring to FIG. 10, the Process Fund Transactions-Retrieve screen 1000 illustrates the trades for which a price is not yet available in the trades listing 1008. The trades in the listing are those that are less than or equal to the trade date 1004 and the price cycle 1006. Once the price become available, the system retrieves the trades in the held state, determines the share amount and posts the shares.

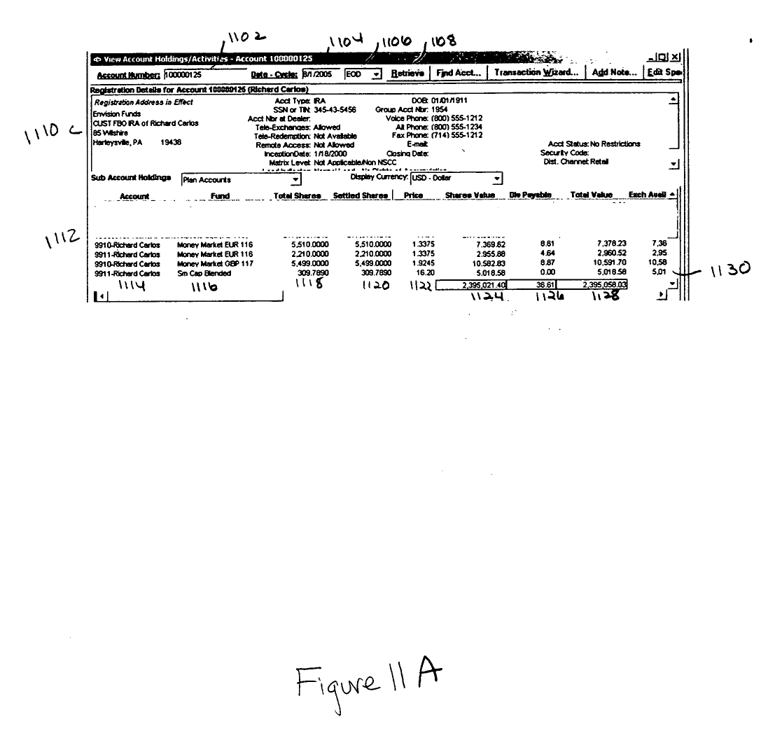

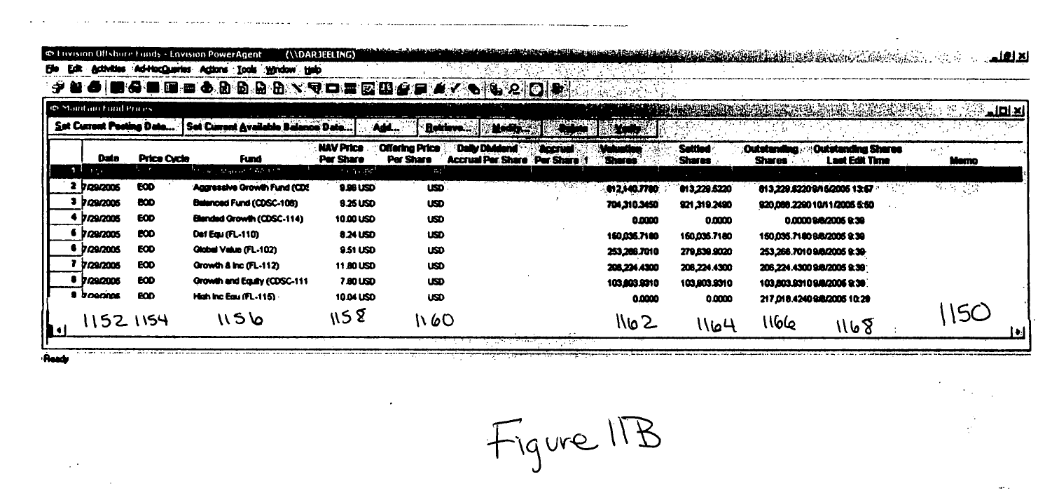

Once the NAV for the pricing cycle is available, the system and method of the present invention provides for posting the number of shares associated with the trade wherein the shares purchased or redeemed during the pricing cycle are purchased or sold at a price equivalent to the net asset value determined at the end of the pricing cycle. The outstanding shares for the mutual fund and available balances for the shareholder accounts in a mutual fund are also produced at the end of the pricing cycle and account information displayed immediately after posting the NAV. With reference to FIG. 11A, the view account holding/activities screen 1102 illustrates account information for an account which has just posted a NAV. The screen 1102 includes the account number 1102, the trade date 1104, the price cycle 1106, the account holder registration information 1108, account information 1112, and trade history for the account 1132. In the present example, the account information for account number 100000125 is illustrated for a trade made on Aug. 1, 2005 1104 with an end of day price cycle 1106. The information made available, immediately after posting the NAV, includes the fund name 1116, the total number of shares 1118, the number of settled shares 1120, the price 1122, share value 1124, the payable dividend 1126, the total value 1128 and the exchange account balance 1130. With reference to FIG. 11B, screen 1150 illustrates a summary screen for Outstanding Shares for the Fund and Account Balances. The screen 1150 includes fields for the date 1152, the pricing cycle 1154, the fund name 1156, the NAV price per share 1158, the offering price per share 1160, valuation shares 1162, settled shares 1164, outstanding shares 1166 and outstanding shares last edit time 1168.

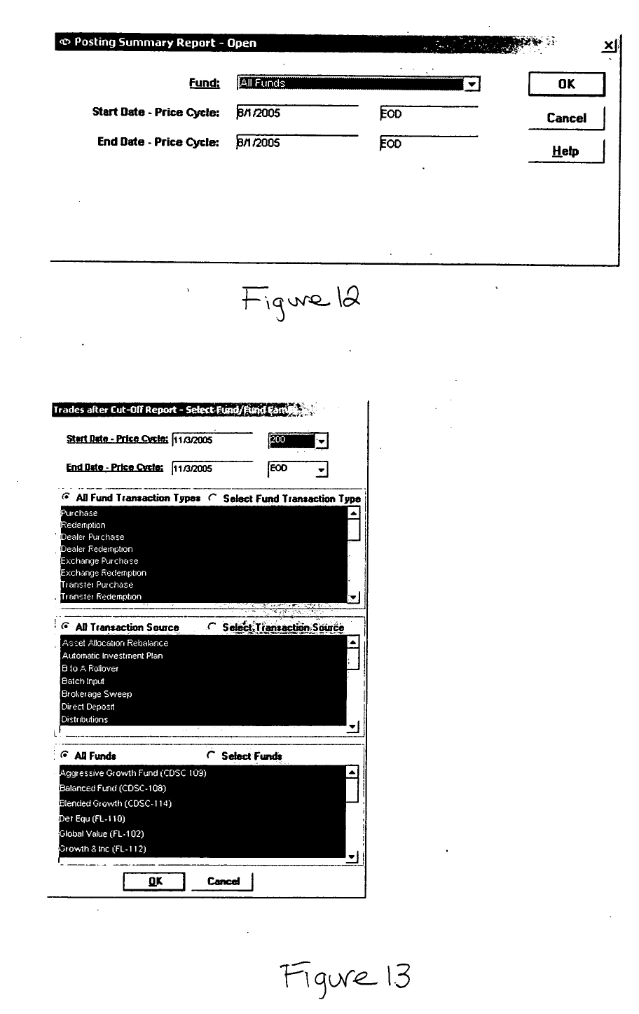

The system and method of the present invention also provides for viewing a variety of reports immediately after posting the NAV. The method and system provides for the production and viewing of a variety of reports including, but not limited to, posting summary, posting details, money transaction details, transaction journal, shareholders on record, combined account holdings, consolidated account summary sheet, cumulative gain loss, exchange activity, fund daily roll forward summary, fund transaction details, master plan activity, master plan holdings activity, master plan holdings, and wire order settlements reports. A parameter screen for a specific report is illustrated in FIG. 12, allowing a user to establish parameters to view a posting summary report for a fund selected from a drop down list 1202, having a given start date 1204, price cycle 1206, end date 1208 and end price cycle 1210. As illustrated in FIG. 13, a user may also view the a report containing the trades that occurred after a price cycle cutoff based on the fund transaction type 1310, the transaction source 1312 or the fund name 1314 by entering the start date 1302, the start price cycle 1304, the end date 1306 and the end price cycle 1308.

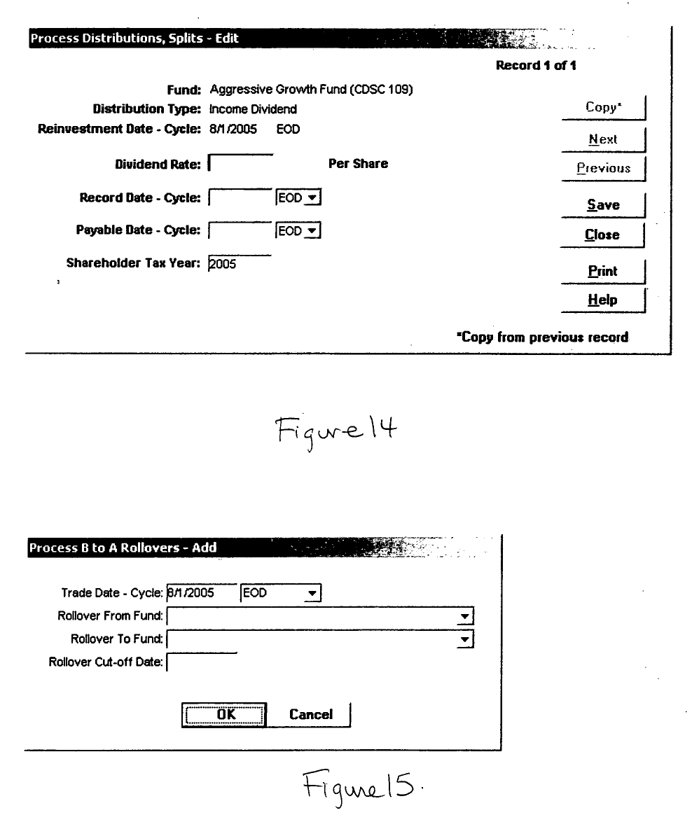

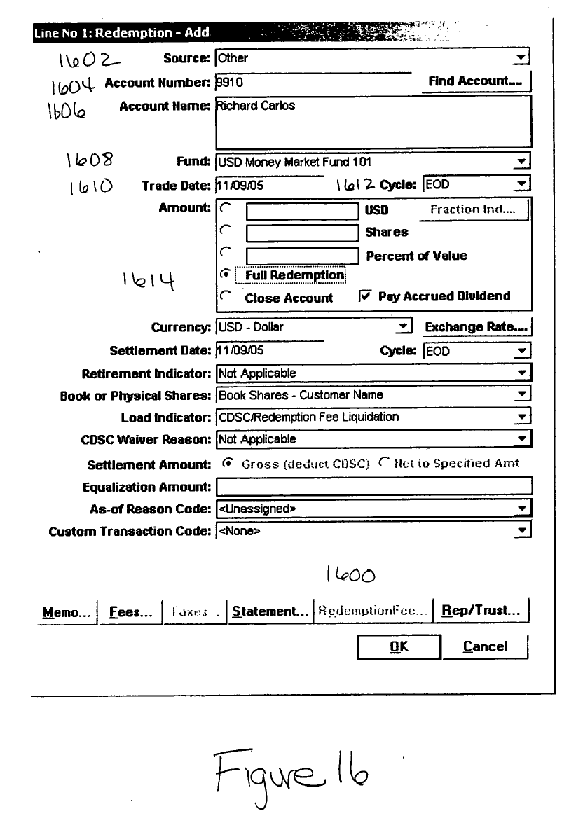

FIG. 14 illustrates a screen which creates exchange transactions for dividend distribution by entering the fund 1402, the dividend rate 1404, the record date 1406, the record cycle 1408, the payable date 1410, the payable cycle 1412 and the shareholder tax year 1414. FIG. 15 illustrates a screen which creates exchange transactions, rolling assets from one fund to another based on defined criteria. In the Process B to A Rollover screen 1500, the user enters the trade date 1502, the trade cycle 1504, the rollover from fund information 1506, the rollover to fund information 1508 and the rollover cutoff date 1510. The results of this process are available for viewing after the pricing cycle.

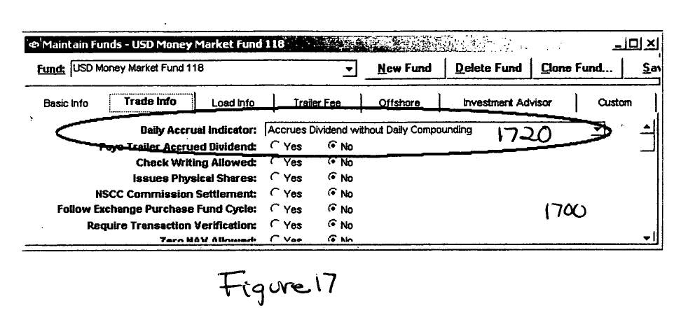

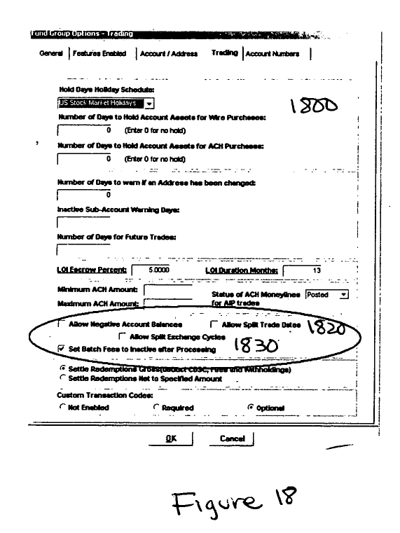

The method of the present invention also provides calculating an accrual payout on a full-liquidation of shares during a pricing cycle. For full-redemptions and exchange redemptions, the system calculates the accrued dividend, owed on any transaction, and includes the amount as part of the transaction. On full redemptions, where an accrual is applicable, the accrual is calculated based on the accrual rate entered for that pricing cycle and is included as part of the redemption. As illustrated in FIG. 16, this option is applicable for accrual funds where a daily dividend per share is entered along with the price in field 1620 along with the fund name, 1605, the trade date 1610 and the pricing cycle 1615. This requires that a fund be setup as referenced in FIG. 17, accrual information is also entered at the fund level in the daily accrual indicator field 1720. On full exchange redemptions, dividends accrued through prior day follows the split on the exchange. Current day dividends follow the last cycle fund.

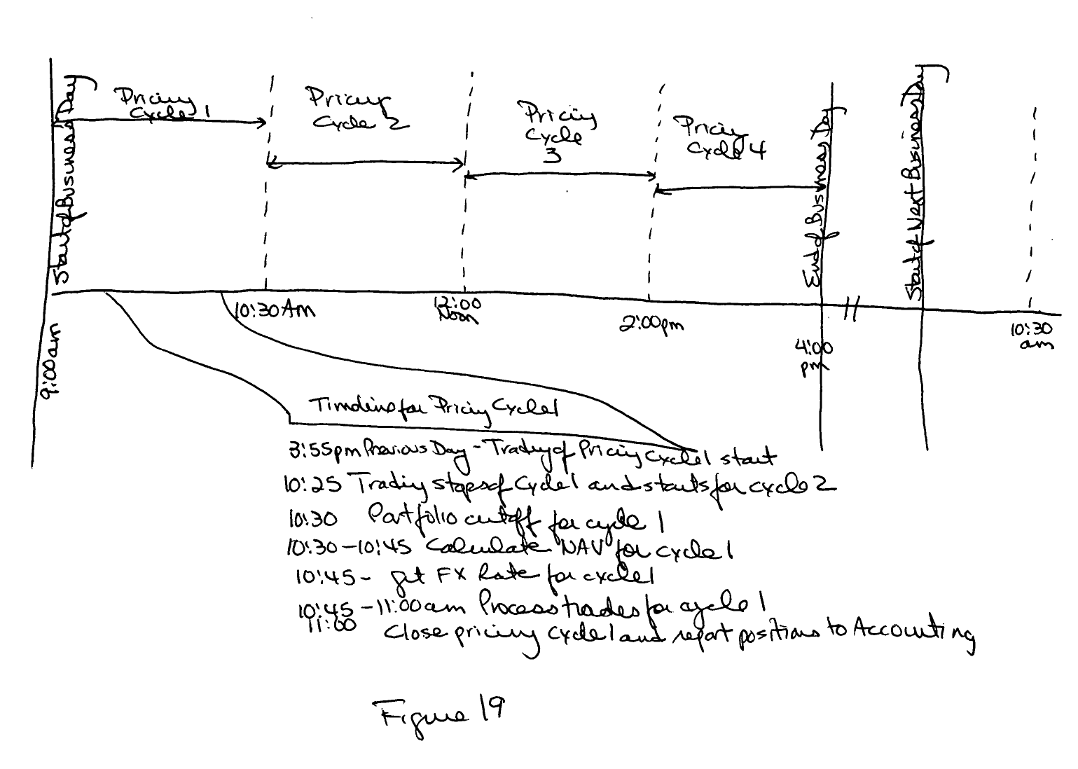

The method of the present invention also provide for redemptions in the same cycle, different cycles and different trading dates. FIG. 18 illustrates a Redemption screen 1600 with source field 1602, account number field 1604, account name field 1606, fund name field 1608, trade date 1610, price cycle name 1612, and full redemption checkbox 1614. To entered a trade as a redemption, the full redemption checkbox 1614 is checked and the OK button 1620 is clicked. When the NAV is available, the Daily Dividend Accrual Per Share 910 and/or Accrual Per Share Period in Days 912 values are entered as illustrated in FIG. 9. For full exchange redemptions purchasing into multiple funds across multiple cycles, the dividends accrued through the prior day follows the allocation of the exchange purchases and the current day dividends are included only in the “last” fund. In a full exchange redemption from Money Market purchasing 25% of the redemption into four different funds into the last cycle of the day, the dividends accrued through the prior day are allocated 25% to each of the four funds and the current day dividends are calculated using the current and of day factor and are split 25% to each fund. In a full exchange redemption from Money Market to two cycles other than last cycle of the day, the dividends accrued through the prior day are allocated 50% to each of the two funds and the current day dividends are calculated using the current day factor for that cycle and are split 50% to each fund. In a full exchange redemption from Money Market during an early cycle purchasing 25% of the redemption into two early cycle funds and into two end of day cycle funds, the dividends accrued through the prior day are allocated 25% to each of the four funds and the current day dividends added to the last fund listed for the last cycle. At posting, the system uses the accrual through the prior day to determine the 25% allocation for each of the early cycle funds. When the other two exchanges post in the end of day cycle, the system uses the accrual, through the prior day, to determine the 25% allocation to both end of day funds. The current day dividends are calculated on the full Money Market balance at the beginning of the trade using the end of day factor. Those current day dividends are added to the last fund listed for the last cycle included in the trade.

Full redemption exchanges entered for an earlier trade dates/cycles should use the factor for the specified date and cycle to calculate any current day dividends. For example, a full redemption exchange from Money Market entered during the end of day cycle with a trade date for today and the early cycle should calculate any dividends based on the early cycle factor.

Referring now to FIG. 19, there is shown a diagram illustrating the operation of the present invention to implement intra-day pricing of a mutual fund in multiple currencies. During the first pricing cycle (i.e., 9:00 am-10:30 am), the assets held by the mutual fund are traded on various exchanges. From 3:55 pm (on the previous trading day) to 10:25 am (on the current trading day), the mutual fund receives orders from the public or institutional investors to purchase shares in the mutual fund and, during the same pricing cycle, the mutual fund receives requests from the public or institutional investors to redeem shares of the mutual fund. These fund orders and redemption requests are received in the context of US dollars or multiple different foreign currencies. At 10:25 am (5 minutes before the end of first pricing cycle), the mutual fund ceases accepting such purchase orders or redemption requests for the first pricing cycle. As described below, all purchase orders or redemption requests received from 3:55 pm (on the previous trading day)-10:25 am (on the current trading day) are processed using the NAV calculated at the end of the first pricing cycle, and all purchase orders or redemption requests received after this 10:25 am cutoff (and before the next cutoff at 11:55 am) are processed using the NAV calculated at the end of the second pricing cycle.

At 10:30 am, trading for the first pricing cycle of the assets held by the mutual fund on various exchanges ends, and trading for the next pricing cycle of the assets held by the mutual fund on various exchanges begins.

Between 10:30 am-10:45 am, a NAV for each share in the mutual fund is determined using the market price of each asset held by the fund at the time trading of assets held by the mutual fund for the first pricing cycle ended (i.e., 10:30 am). The NAV is calculated in the context of a base currency (e.g., US dollars).

At 10:45 am, foreign exchange rates are obtained corresponding to the then current exchange rate between the base currency and each foreign currency in which a purchase order or redemption request was received during the first pricing cycle.

Next, between 10:45 am-11:00 am, all purchase orders or redemption requests received from 9:00 am-10:25 am are processed using the NAV calculated at the end of the first pricing cycle (i.e., the NAV calculated between 10:30 am-10:45 am) and the foreign exchange rates obtained at 10:45 am.

At 11:00 am, a report is sent to the accounting department of the mutual fund identifying the purchase orders and redemption requests processed for the first pricing cycle.

Referring still to FIG. 19, the above described process is then repeated during each subsequent interval, in order to implement intra-day pricing of the mutual fund for four pricing cycles throughout the trading day.

The embodiments shown in FIGS. 1-19 may be implemented in software that operates on one or more servers maintained by the mutual fund or its designee.

It will be understood by those skilled in the art that the particular duration of the pricing cycles and components shown in FIGS. 1-19, and the timing and sequence of events associated with each pricing as explained above, represent examples of particular embodiments of the present invention, and should not be interpreted as limiting the scope of the present invention. Various modifications may be made to the particular time intervals and sequences disclosed in connection with FIGS. 1-16, and such variations are considered to be within the scope of the present invention. It is understood, therefore, that this invention is not limited to the particular embodiments disclosed, but is intended to cover modifications within the spirit and scope of the present invention as defined in the appended claims.

What is claimed is:

1. A computer-implemented method for facilitating the purchase and sale of shares in an open-ended mutual fund during a trading day when assets held by the mutual fund fluctuate in value as the assets trade on one or more exchanges, the method comprising:
dividing at least a portion of the trading day into a plurality of pricing cycles such that the interval between the beginning of successive pricing cycles is 4 hours or less;
defining the pricing cycle comprising a name, an identification number, trading cutoff times definition, a fund cutoff time, and an estimate cutoff time;
at the end of each pricing cycle, receiving a net asset value associated with each share in the fund based on the values at which individual assets held in the fund traded on one or more exchanges immediately prior to the end of the pricing cycle and the number of shares purchased from the fund and redeemed by the fund during the prior pricing cycle;
entering one or more trades for the purchase or sale of shares during the pricing cycle;
posting a number of shares associated with the trade during one of the subsequent pricing cycles of the trading day, wherein the shares purchased or redeemed during the pricing cycle are purchased or sold at a price equivalent to the net asset value determined at the end of said pricing cycle;
producing outstanding shares for the mutual fund and available balances for the shareholder accounts in a mutual fund at the end of the pricing cycle; and
displaying one or more reports for the one or more trades immediately after posting the value of the trade.

2. The method of claim 1, wherein the trading cutoff times definition comprises a fund transaction source, a stop trading value, an override value.

3. The method of claim 1, further comprising the step of defining a settlement cycle wherein the settlement cycle is defined by the trading day and pricing cycle.

4. The method of claim 1, wherein the trading day comprises a day when the fund is priced at a non-standard time.

5. The method of claim 1 further comprising calculating an accrual payout on a full-liquidation of shares during said pricing cycle.

6. A computer-implemented method for facilitating the purchase and sale of shares in an open-ended mutual fund in a plurality of different currencies during a trading day when assets held by the mutual fund fluctuate in value as the assets trade on one or more exchanges, the method comprising:
dividing at least a portion of the trading day into a plurality of pricing cycles such that the interval between the beginning of successive pricing cycles is 4 hours or less;
defining the pricing cycle comprising a name, an identification number, a trading cutoff time definition, an override value, a fund cutoff time, an exchange rate and an estimate cutoff time;
receiving for each of the plurality of currencies a net asset value associated with each share in the fund based on the values at which individual assets held in the fund traded on one or more exchanges prior to the end of the pricing cycle and the number of shares purchased from the fund and redeemed by the fund during the prior pricing cycle; wherein each of the plurality of different currencies are used to complete requests to purchase at least some shares from the fund and to redeem at least some shares by the fund made during said pricing cycle at a price equivalent to the net asset value determined at the end of said pricing cycle;
entering one or more trades for the purchase or sale of shares during the pricing cycle;
posting a number of shares associated with the trade during one of the subsequent pricing cycles of the trading day, wherein the shares purchased or redeemed during the pricing cycle are purchased or sold at a price equivalent to the net asset value determined at the end of said pricing cycle;
producing outstanding shares for the mutual fund and available balances for the shareholder accounts in a mutual fund at the end of the pricing cycle; and
displaying one or more reports for the one or more trades immediately after posting the value of the trade.

7. The method of claim 6, wherein the trading cutoff times definition comprises a fund transaction source, a stop trading value, and an override value.

8. The method of claim 6, further comprising the step of defining a settlement cycle wherein the settlement cycle is defined by the trading day and pricing cycle.

9. The method of claim 6, wherein the trading day comprises a day when the fund is priced at a non-standard time.

10. The method of claim 6, further comprising calculating an accrual payout on a full-liquidation of shares during said pricing cycle.
